(19) United States
(12) Patent Application Publication
(10) Pub. No.: US 2008/0046902 A1
(43) Pub. Date: Feb. 21, 2008

(54) Disc Device

(75) Inventors: Naohisa Tanabe, Osaka (JP); Yuji Ariyoshi, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka, JP (JP)

(21) Appl. No.: 11/575,365

(22) PCT Filed: Sep. 15, 2005
(86) PCT No.: PCT/JP05/17037

§ 371 Date: Mar. 15, 2007

(30) Foreign Application Priority Data
Sep. 17, 2004 (JP) 2004-271104

(51) Int. Cl. G11B 7/24

(52) U.S. Cl. 720/707

(57) ABSTRACT

A disc device includes the following: a traverse base 5 that can be moved between a recording/reproducing position and a standby position, on which an optical pickup 2 and a turntable 1 are mounted; a front cover 3 including a disc carrying surface 3a and an aperture 3b; a clamp base 10 that can be moved between a first position that does not overlap the disc carrying surface 3a and a second position that overlaps the aperture 3b and includes a damper 11 for clamping the disc 4 to the turntable 1; and an open/close member 9 that is movably provided at the back of the front cover 3 and can cover/uncover the aperture 3b. When the disc 4 is clamped, the clamp base 10 is moved from a standby position to the position overlapping the aperture 3b, then the open/close member 9 is moved to open the aperture 3b, and subsequently the traverse base 5 is moved from the standby position to the recording/reproducing position, thereby clamping the disc 4 with the turntable 1 and the damper 11. This disc device can facilitate the loading of the disc and protect the traverse portion.

### TECHNICAL FIELD

The present invention relates to a disc device that can be loaded with a disc used for recording or reproduction such as CD (compact disk) or DVD (digital versatile disk) or with a disc contained in a case, and can record/reproduce various information signals with respect to the disc.

### BACKGROUND ART

In recent years, a DVD recorder capable of recording/reproducing information signals such as video signals with respect to an information medium (DVD etc.) has begun to be available rapidly. For more widespread use of the DVD recorder in the future, it has been required to develop a device that differs in form from a conventional device.

In the conventional disc device, a tray system or slot-in system has been the mainstream as a configuration that allows a user to insert a disc into the device. Moreover, one of the other configurations is known from Patent Document 1.

A disc device disclosed in Patent Document 1 includes a main body having a turntable and a cover that can open and close so as to cover the front of the main body including the turntable. The cover is provided with a damper for clamping a disc.

A disc is loaded in the disc device by putting it between the main body and the cover, and then the cover is closed, thereby clamping the disc with the turntable and the clamper.

Patent Document 1: JP 1(1989)-151453 U

### DISCLOSURE OF INVENTION

Problem to be Solved by the Invention

In the above conventional configuration, however, the turntable protrudes from the surface of the main body on which the disc is placed. Therefore, the disc touches the turntable while a user inserts the disc into the device. This may damage the disc and the turntable. Moreover, when the cover is opened for insertion/removal of the disc, the turntable is seen from the outside and thus is not desirable in terms of appearance.

The present invention solves the above conventional problems and has an object of providing a disc device that can facilitate the loading of a disc when it is inserted/removed, protect the traverse portion, and improve the appearance.

Means for Solving Problem

To achieve the object, a disc device of the present invention is capable of recording/reproducing information signals with respect to a disc and includes the following: a traverse base that can be moved between a recording/reproducing position and a standby position, on which an optical pickup for recording/reproducing the information signals with respect to the disc and a turntable for rotating the disc at a position where the optical pickup can record/reproduce the information signals with respect to the optical disc are mounted; a front cover including a disc carrying surface that can carry the disc and is fixed between a position of a disc holding portion of the turntable when the traverse base is at the recording/reproducing position and a position of the disc holding portion of the turntable when the traverse base is at the standby position, and an aperture that is formed in the disc carrying surface so as to allow the traverse base to be moved between the standby position and the recording/reproducing position; a clamp base that can be moved between a first position where the clamp base is located parallel to the disc carrying surface and does not overlap the disc carrying surface and a second position where the clamp base overlaps the aperture, has a size large enough to cover the aperture at the second position, and includes a damper for clamping the disc to the turntable; and an open/close member that is movably provided at the back of the front cover and can be moved to cover/uncover the aperture. When the disc is clamped, the clamp base is moved from a standby position to a position where the clamp base overlaps the aperture, then the open/close member is moved from a position where the aperture is closed to a position where the aperture is opened, and subsequently the traverse base is moved from the standby position to the recording/reproducing position, thereby clamping the disc with the turntable and the clamper.

With this configuration, the turntable is always hidden by the cover and cannot be seen from the front of the device during the period between the insertion/removal of the disc and the recording/reproducing state. Thus, it is possible to achieve excellent effects of facilitating the loading of a disc, protecting the traverse portion, and improving the appearance of the disc device.

### EFFECTS OF THE INVENTION

As described above, the present invention uses the open/close member for covering the aperture that is formed in the disc carrying surface and allows the turntable to pass through, and the clamp member for clamping the open/close member and the disc to the turntable, thereby always hiding the traverse portion so as not to be seen from the front of the device during the period between the insertion/removal of the disc and the recording/reproducing state. Thus, it is possible to achieve excellent effects of facilitating the loading of a disc, protecting the traverse portion, and improving the appearance of the disc device.

### BRIEF DESCRIPTION OF DRAWINGS

FIG. 1 is a perspective view showing the appearance of a disc system employing a disc device in Embodiment 1 of the present invention.

FIG. 2 is a perspective view showing the appearance of the disc system in Embodiment 1.

FIG. 3 is a plan view showing a disc loading state of a disc device in Embodiment 1.

FIG. 4 is a cross-sectional side view showing the disc loading state of the disc device in Embodiment 1.

FIG. 5 is an enlarged cross-sectional view showing an upper supporting portion of a clamp base in Embodiment 1.

FIG. 6 is an enlarged cross-sectional view showing a lower supporting portion of the clamp base in Embodiment 1.

FIG. 7 is a plan view showing a state in which the clamp base of the disc device in Embodiment 1 has been moved to a clamp position.

FIG. 8 is a plan view showing a disc clamping state of the disc device in Embodiment 1.

FIG. 9 is a cross-sectional side view showing the disc clamping state of the disc device in Embodiment 1.

FIG. 10 is a plan view showing another operation example of the disc device in Embodiment 1.

### DESCRIPTION OF REFERENCE NUMERALS

1 Turntable

2 Optical pickup

3 Front cover

3a Disc carrying surface

3b Aperture

4 Disc

5 Traverse base

9 Open/close member

10 Clamp base

11 Clamper

### BEST MODE FOR CARRYING OUT THE INVENTION

The disc device of the present invention may have the following configuration. During the transition from the insertion of the disc to the recording/reproducing state, the clamp base is moved to a position where the clamp base covers the aperture that is exposed as the open/close member opens. During the transition from the recording/reproducing state to the removal of the disc, the clamp base stays at the position to cover the aperture until the open/close member closes so that the aperture disappears, and subsequently is moved to the standby position.

The open/close member may have a recess in a portion opposed to the turntable.

Hereinafter, a preferred embodiment of the present invention will be described with reference to the drawings.

### Embodiment 1

First, the configuration of a disc system including a disc device of the present invention will be described.

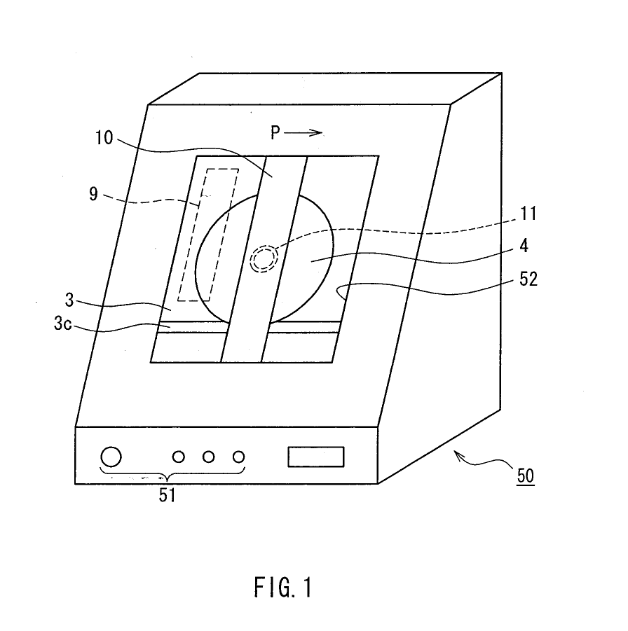

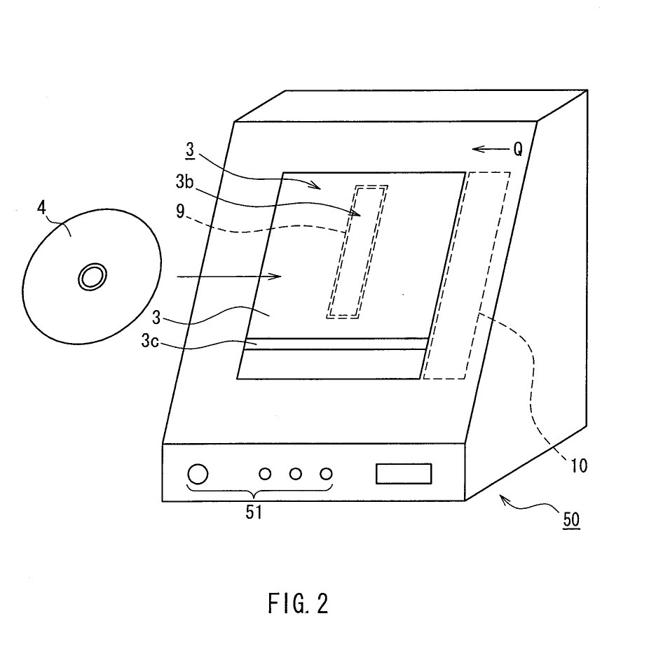

FIGS. 1 and 2 are perspective views showing the appearance of the disc system. FIG. 1 shows a recording/reproducing state and FIG. 2 shows a disc loading state. In the “recording/reproducing state”, a disc 4 is clamped with a turntable and a damper (neither is shown), and information signals can be recorded/reproduced with respect to the disc 4. In the “disc loading state”, a clamp base 10 (which will be described later) is withdrawn to a position that cannot be seen from the outside, and a user can insert/remove the disc 4 into/from the device.

In FIGS. 1 and 2, the disc system 50 is a stationary disc player or disc recorder and has an opening 52 at the front. A disc device that clamps a disc and can record/reproduce the information signals with respect to the disc, as will be described later, is placed in a vertical position inside the opening 52. The user can put the disc 4 into the disc device through the opening 52. Since the opening 52 is formed in the front of the disc system 50 that is substantially perpendicular to the bottom (ground surface), the disc 4 can be held upright when the user inserts/removes it into/from the disc device.

A control portion 51 for performing various operations of the disc system 50 is provided near the opening 52 of the disc system 50. The operations performed by the control portion 51 may be, e.g., a reproduction operation of reproducing the information signals recorded on the disc 4, a recording operation of recording the information signals on the disc 4, and an ejection operation of shifting the disc 4 from the recording/reproducing state to the disc loading state, but are not limited thereto.

A front cover 3 supports the disc 4 that has been inserted into the disc device by the user. The front cover 3 includes a disc carrying surface 3a, an aperture 3b for exposing a turntable and an optical pickup mounted on the lower portion of the disc carrying surface 3a, and a rib 3c for controlling the position of the disc 4 in a downward direction. While the disc 4 is loaded in the disc device, a part of the recording surface is supported by the disc carrying surface 3a, and a part (lower edge) of the outer circumference is supported by the rib 3c.

An open/close member 9 is a substantially plate-shaped member and has a principal surface large enough to cover the aperture 3b. The open/close member 9 is located at the back of the disc carrying surface 3a and movable in either direction of the arrow P or Q.

A clamp base 10 is located over the disc carrying surface 3a in the disc system 50 and movable in either direction of the arrow P or Q. A clamper 11 for clamping the disc 4 is provided in the back of the clamp base 10.

The operations of the disc system 50 will be described below.

The disc system 50 is in the state of FIG. 2 when the power is off. That is, the clamp base 10 is at a standby position where it is not exposed to the outside, and the open/close member 9 is at a position where it covers the aperture 3b.

In operating the disc system 50, the power is turned on by manipulating the control portion 51 in the state of FIG. 2. Then, the disc 4 is placed on the disc carrying surface 3a and the rib 3c. Subsequently, e.g., a reproduction button of the control portion 51 is actuated, and the clamp base 10 starts moving in the direction of the arrow Q. After the clamp base 10 has been moved to a position overlapping the center of the disc 4, the open/close member 9 starts moving in the direction of the arrow Q. The open/close member 9 is moved to a standby position, as shown in FIG. 1. In the state of FIG. 1, the clamp base 10 is positioned to cover the aperture 3b (see FIG. 2), and the open/close member 9 is positioned to uncover the aperture 3b.

Next, a traverse (not shown) on which the turntable and the optical pickup are mounted is moved to a position accessible to the disc 4, and thus the disc 4 can be clamped with the turntable and the damper 11. At this time, while the center hole of the disc 4 comes into contact with a tapered portion of the turntable, the disc 4 is guided by the tapered portion and moved upward. Accordingly, the outer circumference of the disc 4 is moved to a position not in contact with the rib 3c.

Next, the turntable rotates the disc 4, and the information layer of the disc 4 is irradiated with a light beam using the optical pickup, thereby reproducing the information signals recorded on the disc 4. Although the reproduction operation of the disc 4 has been described above, the recording operation for recording the information signals on the disc 4 also can be performed in the same manner. In the above description, the reproduction button is actuated after the power is on. However, it is also possible to actuate only the reproduction button with the power remaining off, so that the power of the disc system 50 is turned on, and the disc 4 is shifted in the reproducing state.

When the disc 4 is taken out of the disc system 50, an ejection button of the control portion 51 is actuated in the state of FIG. 1, and thus the irradiation of the light beam from the optical pickup is stopped, followed by the rotation of the turntable. Then, the traverse is moved back to a standby position (that is farther from the front in the direction passing through the center of the disc 4), and the disc 4 clamped with the damper 11 and the turntable is released. Subsequently, the clamp base 10 and the open/close member 9 start moving in the direction of the arrow P to their respective positions as shown in FIG. 2. Thus, the user can take out the disc 4 that is resting on the disc carrying surface 3a and the rib 3c.

A specific configuration of the disc device of Embodiment 1 will be described below.

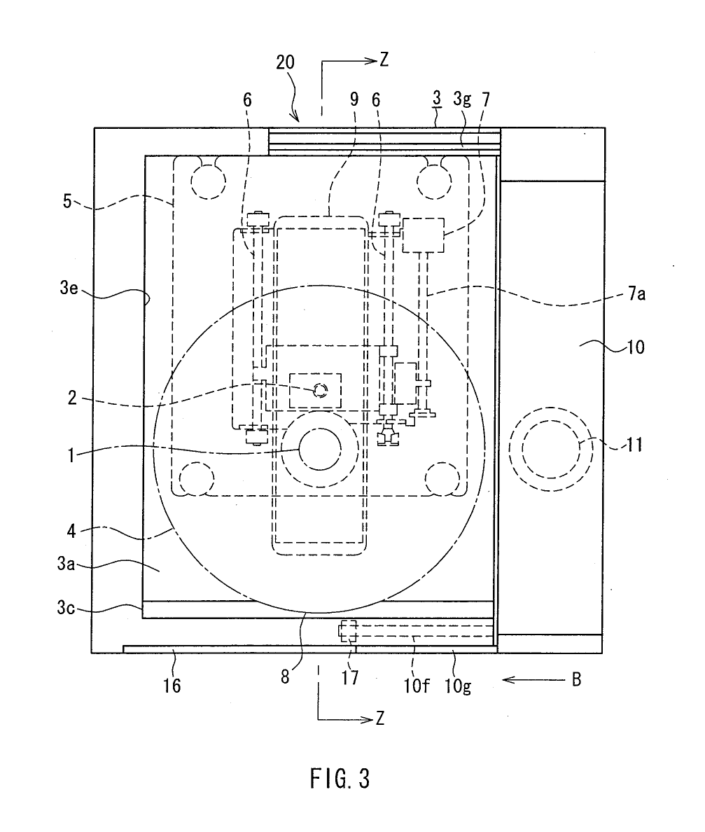

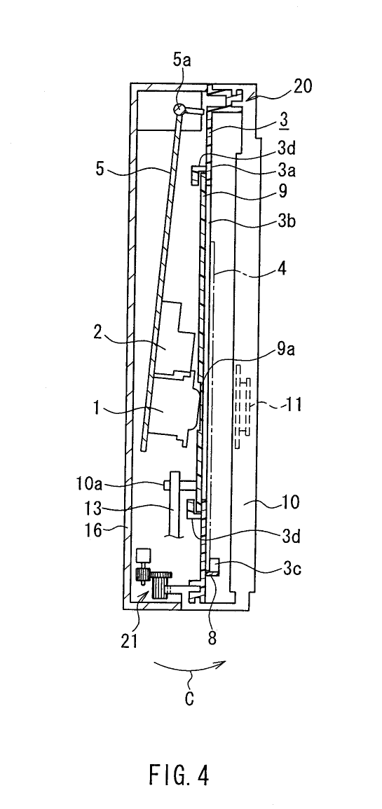

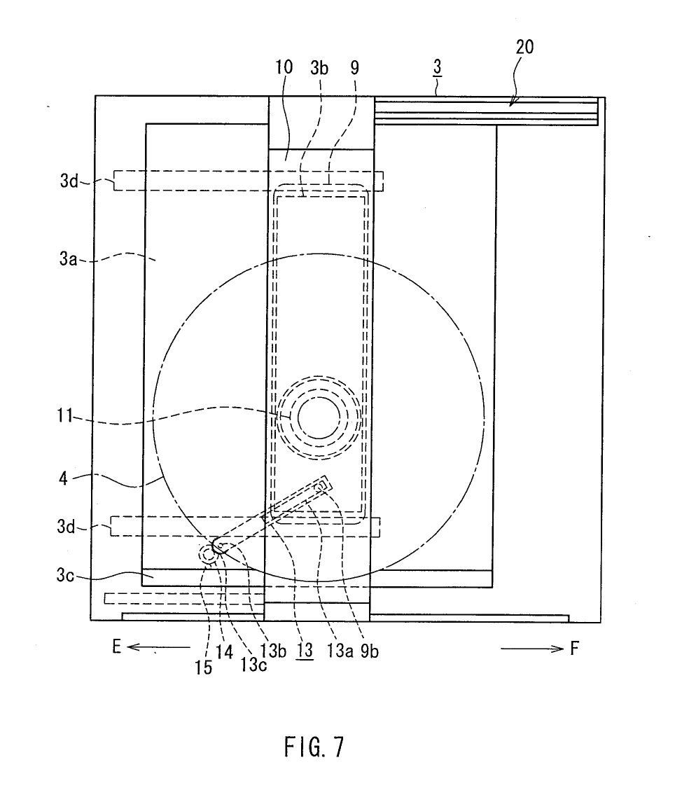

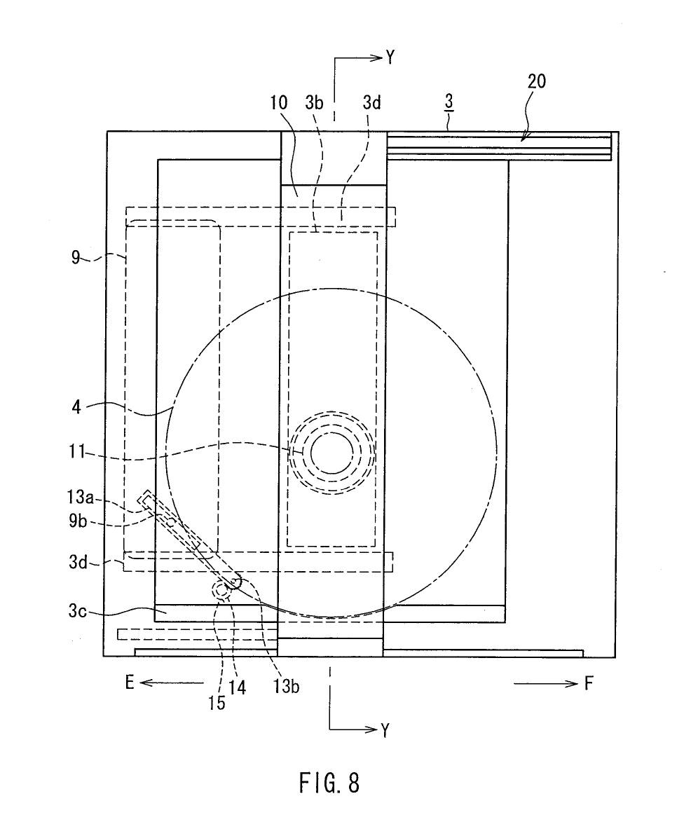

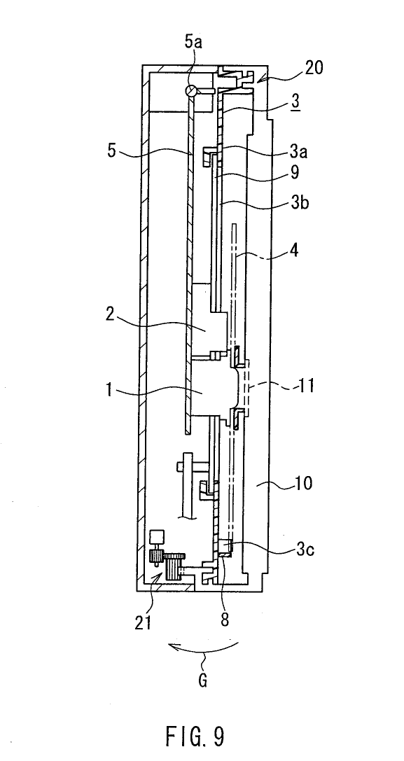

FIG. 3 is a plan view showing the disc loading state of the disc device in Embodiment 1 of the present invention. FIG. 4 is a cross-sectional side view of the disc loading state of the disc device, taken along the line Z-Z in FIG. 3. FIG. 7 is a plan view showing a state in which the clamp base in the disc loading state (FIG. 3) has been moved to a position (clamp position) that overlaps the aperture when viewed on a projection plane. FIG. 8 is a plan view showing the completion of the disc clamping state of the disc device. FIG. 9 is a cross-sectional side view showing the completion of the disc clamping state of the disc device, taken along the line Y-Y in FIG. 8. The same components as those in FIGS. 1 and 2 are denoted by the same reference numerals and described in more detail.

In FIGS. 3 to 9, a turntable 1 holds the disc 4 and is rotationally driven with a motor to rotate the disc 4 during recording or reproduction. A tapered portion (see FIG. 4) is formed in the vicinity of a disc holding surface of the turntable 1. When the disc 4 is clamped, the tapered portion is inserted into the center hole of the disc 4 and can hold the disc 4 by aligning it with the rotation center of the turntable 1. The position and shape of the tapered portion are such that it can be inserted into the center hole of the disc 4 placed on the rib 3c (which will be described later) for clamping.

An optical pickup 2 is used to record/reproduce the information signals with respect to the information layer of the disc 4. The information signals recorded/reproduced by the optical pickup 2 may be, e.g., digitized and compressed video signals or sound signals, or various information signals that can be handled with a computer.

The front cover 3 is substantially in the form of a plate and covers the front of the disc device. The front cover 3 includes the disc carrying surface 3a, the aperture 3b, the rib 3c, guide portions 3d, a wall portion 3e, and guide grooves 3f to 3i.

The disc carrying surface 3a is located perpendicular to the direction of the optical axis of the optical pickup 2. When the disc 4 is put on the front cover 3 and loaded in the disc device, the disc carrying surface 3a supports the recording surface of the disc 4.

The aperture 3b is formed substantially in the middle of the disc carrying surface 3a. As shown in FIGS. 4 and 9, the aperture 3b allows the disc holding surface of the turntable 1 to pass through at the time of switching between the disc loading state and the recording/reproducing state. Moreover, the aperture 3b is provided so that the information layer of the optical disc 4 can be irradiated with a light beam emitted from the optical pickup 2.

The rib 3c is formed in the vicinity of the lower end of the front cover 3, as shown in FIG. 3. When the disc 4 is put on the front cover 3, the rib 3c supports the lower edge of the disc 4. Moreover, a substantially arc-shaped concave portion 8 is formed substantially in the middle of the rib 3c in its longitudinal direction, so that the disc 4 can be supported along the edge, and horizontal centering of the disc 4 also can be performed. As shown in FIG. 4, the amount of protrusion of the rib 3c in the direction substantially perpendicular to the disc carrying surface 3a is designed with dimensions sufficient to support the disc when the disc device is placed in a vertical position (i.e., placed in such a way that the disc carrying surface 3a is substantially perpendicular to the surface on which the device stands).

The guide portions 3d are formed on the back of the front cover 3 in the vicinity of the upper and lower edges of the aperture 3b, respectively, as shown in FIG. 7. Moreover, the open/close member 9 is slidably supported by the guide portions 3d, as shown in FIG. 4.

The wall portion 3e is formed around the disc carrying surface 3a, as shown in FIG. 3. When the disc 4 is placed on the disc carrying surface 3a, the wall portion 3e generally controls the position of the disc 4 in a lateral direction.

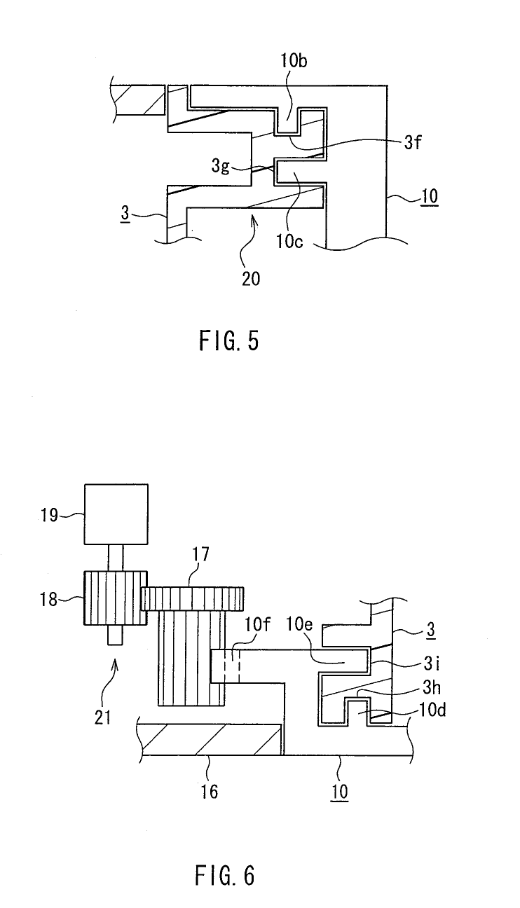

The guide grooves 3f and 3g are formed in the upper end of the front cover 3, and the upper end of the clamp base 10 is slidably supported by the guide grooves 3f, 3g. As shown in FIG. 5, a lug 10b of the clamp base 10 is engaged with the guide groove 3f, thereby not only controlling the position in a horizontal direction of FIG. 5, but also preventing the clamp base 10 from slipping off the front cover 3. Moreover, a lug 10c of the clamp base 10 is engaged with the guide groove 3g, thereby controlling the position in a vertical direction of FIG. 5.

The guide grooves 3h and 3i are formed in the lower end of the front cover 3, and the lower end of the clamp base 10 is slidably supported by the guide grooves 3h, 3i. As shown in FIG. 6, a lug 10d (which will be described later) of the clamp base 10 is engaged with the guide groove 3h, thereby not only controlling the position in a horizontal direction of FIG. 6, but also preventing the clamp base 10 from slipping off the front cover 3. Moreover, a lug 10e (which will be described later) of the clamp base 10 is engaged with the guide groove 3i, thereby controlling the position in a vertical direction of FIG. 6.

A chassis 16 is fixed to the front cover 3 and covers the back that is on the other side of the disc carrying surface 3a.

The turntable 1 and the optical pickup 2 are mounted on a traverse base 5. The traverse base 5 is supported by the chassis 16 so as to be rotatable about a shaft 5a between a standby position and a recording/reproducing position. The “standby position” is where the disc holding surface of the turntable 1 and the optical pickup 2 do not protrude from the disc carrying surface 3a of the front cover 3 (i.e., they are positioned lower than the disc carrying surface 3a). The “recording/reproducing position” is where the disc holding surface of the turntable 1 protrudes from the disc carrying surface 3a of the front cover 3, and the disc 4 is placed on the disc holding surface of the turntable 1. The rotational mechanism of the traverse base 5 is not shown, but may include, e.g., a motor and a gear.

The optical pickup 2 is movably supported by guide shafts 6. A drive motor 7 has a shaft 7a that can output a rotational driving force. The optical pickup 2 is threadably mounted on the shaft 7a, and the rotation of the shaft 7a can move the optical pickup 2 in the radial direction of the disc 4 while being supported by the guide shafts 6.

The open/close member 9 is slidably provided inside the front cover 3 and can slide between a first position where it covers the aperture 3b, as shown in FIGS. 3 and 7, and a second position where it uncovers the aperture 3b and does not interfere with the rotational movement of the traverse base 5, as shown in FIG. 8. The sliding direction of the open/close member 9 is indicated by the arrow E (FIG. 7) when it slides from the first position to the second position and by the arrow F when it slides from the second position to the first position. The open/close member 9 has a shape and size suitable for covering the aperture 3b so that the inside of the device cannot be seen through the aperture 3b at the first position. In other words, when the open/close member 9 is at the first position, the size is larger than a projection plane of the aperture 3b in a vertical direction. A pin 9b is formed on the back of the open/close member 9.

As shown in FIG. 4, the open/close member 9 has a recess 9a in the back. The recess 9a is formed so that a part of the turntable 1 is located within the recess 9a when the open/close member 9 is at the first position. This can prevent contact between the open/close member 9 and the turntable 1. In such a case, any other members as well as the turntable 1 may be located within the recess 9a. Although the open/close member 9 of this embodiment has only one recess 9a in the back, it also may have a plurality of recesses. Due to the formation of the recess 9a in which other members such as the turntable 1 are located, the sliding movement of the open/close member 9 is not prevented, and the whole device can be smaller in size.

In the disc loading state of FIG. 3, the clamp base 10 is on standby at a position that does not overlap a projection plane of the disc carrying surface 3a in the direction of the optical axis of the optical pickup 2, so that the disc 4 does not touch the clamp base 10 when it is placed on the disc carrying surface 3a of the front cover 3. In this embodiment, the clamp base 10 is on standby at the right position of disc carrying surface 3a, as shown in FIG. 3. However, the clamp base 10 may be on standby at the left position of the disc carrying surface 3a. Moreover, the clamp base 10 can be moved from the standby position shown in FIG. 3 to a clamp position shown in FIG. 7. The “clamp position” is where the clamp base 10 has been moved directly above the disc holding surface of the turntable 1 and can perform clamping. There is a clearance between the clamp base 10 and the disc carrying surface 3a, and thus allows the clamp base 10 not to touch the disc 4 placed on the disc carrying surface 3a during the sliding movement. The clamp base 10 includes a rack member 10g for supporting and guiding the lower end thereof. As shown in FIG. 6, the rack member 10g has the lug 10d that is engaged with the groove 3h of the front cover 3, the lug 10e that is engaged with the groove 3i of the front cover 3, and a rack 10f to which a driving force is transferred from a transfer mechanism 21 (which will be described later). The rack member 10g is provided along the direction of movement of the clamp base 10.

The transfer mechanism 21 can cause a sliding movement of the clamp base 10 and includes a double gear 17, a motor gear 18, and a motor 19. The motor gear 18 is mounted on an output shaft of the motor 19. The double gear 17 is engaged with both the motor gear 18 and the rack 10f. Thus, a rotational driving force output from the motor 19 is transferred to the rack 10f via the motor gear 18 and the double gear 17, and the clamp base 10 can slide.

The damper 11 for clamping the disc 4 to the disc holding surface of the turntable 1 is provided in the clamp base 10 so as to be movable in the direction perpendicular to the disc holding surface of the turntable 1. The damper 11 contains a magnetic body and is attracted to the disc holding surface of the turntable 1, containing an oppositely polarized magnetic body, by the magnetic force between the two magnetic bodies.

A cam lever 13 can pivot about a pivotal axis 13b formed in the front cover 3. The cam lever 13 has a slot 13a in which the pin 9b of the open/close member 9 is movably inserted. Moreover, teeth 13c are formed at the end of the cam lever 13.

A motor gear 15 is mounted on an output shaft of a motor (not shown) for sliding the open/close member 9 and engaged with a double gear 14 (which will be described later).

The double gear 14 is engaged with both the teeth 13c of the cam lever 13 and the motor gear 15 and transfers a driving force from the motor gear 15 to the cam lever 13.

The operations of the disc device having the above configuration will be described below.

First, in the disc loading state of FIG. 3, the open/close member 9 is at the first position (where it covers the aperture 3b), and the clamp base 10 is at the standby position (where it does not overlap the disc carrying surface 3a when viewed on a projection plane). As shown in FIG. 4, the traverse 5 is withdrawn so that the turntable 1 does not protrude from the surface of the front cover 3. In this case, a part of the turntable 1 is located within the recess 9a of the open/close member 9.

Next, a user puts the disc 4 on the rib 3 and actuates a switch (not shown) to start the recording or reproduction operation. Then, the clamp base 10 is moved from the standby position shown in FIG. 3 in the direction of the arrow B, which is perpendicular to the direction of movement of the optical pickup 2, to the clamp position shown in FIG. 7 by the transfer mechanism 21 (see FIG. 6). The surface of the clamp base 10 opposed to the disc carrying surface 3a is larger than a projection plane of the aperture 3b. Therefore, the clamp base 10 that has been moved to the clamp position can cover the aperture 3b and make the inside of the aperture 3b invisible to the user.

The clamp base 10 is moved by the transfer mechanism 21. In FIG. 6, when a current is applied to the motor 19 and rotates the output shaft, a rotational driving force is transferred to the rack 10f via the motor gear 18 and the double gear 17. With the driving force transferred to the rack 10f, the clamp base 10 can slide in the direction of the arrow B (see FIG. 3). The clamp base 10 is supported and guided by the rack member 10g during the sliding movement.

Subsequently, the open/close member 9 in the state of FIG. 7 starts moving in the direction of the arrow E, while being supported by the guide portions 3d, to the second position that does not interfere with at least the rotational movement of the traverse base 5, as shown in FIG. 8. Thus, the traverse base 5 can pass through the aperture 3b.

The open/close member 9 can be moved by transferring a rotational driving force from a motor (not shown) to the teeth 13c of the cam lever 13 via the motor gear 15 and the double gear 14. When the driving force is transferred from the double gear 14, the cam lever 13 pivots about the pivotal axis 13b from the position shown in FIG. 7 in a counterclockwise direction. The pin 9b provided on the back of the open/close member 9 is movably inserted into the slot 13a of the cam lever 13. Therefore, the pin 9b is pushed by the inner wall of the slot 13a as the cam lever 13 rotates, causing the open/close member 9 to move in the direction of the arrow E.

Next, the traverse base 5 rotates about the shaft 5a from the position shown in FIG. 4 in the direction of the arrow C, and the turntable 1 is moved to the recording/reproducing position through the aperture 3b, as shown in FIG. 9. At this time, while the center hole of the disc 4 comes into contact with the tapered portion of the turntable 1, the disc 4 is guided by the tapered portion and moved upward. Accordingly, the outer circumference of the disc 4 is lifted to a position not in contact with the rib 3c.

In this case, due to the force of attraction generated between the magnetic body in the damper 11 and the oppositely polarized magnetic body in the turntable 1, the damper 11 is attracted to the disc holding surface of the turntable 1. Thus, the disc 4 is clamped with the turntable 1 and the damper 11, resulting in the recording/reproducing state, as shown in FIG. 9. When clamped, the disc 4 is separated from both the disc carrying surface 3a and the rib 3c, and the recording surface becomes parallel with the direction of movement of the optical pickup 2.

Subsequently, the disc 4 can be rotated by rotating the turntable 1 with a motor (not shown). Then, the optical pickup 2 can be operated to record the information signals on the disc 4 or to reproduce the information signals recorded on the disc 4.

Next, the operation of removing the disc 4 from the disc device will be described.

When an ejection switch (not shown) is actuated while the disc 4 is at the recording/reproducing position, as shown in FIG. 8, the motor that rotates the turntable 1 is stopped, followed by the rotation of the turntable 1 and then the rotation of the disc 4.

Next, as shown in FIG. 9, the traverse base 5 rotates about the shaft 5a in the direction of the arrow G, and thus the recording/reproducing state is shifted to the standby state of FIG. 4. In this case, since the turntable 1 is detached from the damper 11, the clamping state of the disc 4 is released, and the disc 4 is separated from the disc holding surface of the turntable 1. The disc 4 thus separated from the turntable 1 rests on the rib 3c.

A motor (not shown) for driving the open/close member 9 is operated to transfer a rotational driving force to the cam lever 13 via the motor gear 15 and the double gear 14 in FIG. 8. The cam lever 13 pivots about the pivotal axis 13b in a clockwise direction. Since the pin 9b is movably inserted into the slot 13a, it is pushed by the inner wall of the slot 13a as the cam lever 13 rotates. When the pin 9b is pushed, the open/close member 9 starts moving from the second position shown in FIG. 8 in the direction of the arrow F to the first position shown in FIG. 7. The open/close member 9 covers the aperture 3b at the first position, so that the internal mechanism of the device including the traverse base 5 cannot be seen from the outside.

Subsequently, the motor 19 shown in FIG. 6 is operated to transfer a rotational driving force to the rack 10f via the motor gear 18 and the double gear 17. With the driving force transferred to the rack 10f, the clamp base 10 is moved from the clamp position shown in FIG. 7 in the direction of the arrow F to the standby position shown in FIG. 3. In this state, the disc 4 can be removed.

As described above, the aperture 3b through which the turntable 1 can pass is provided in a part of the front cover 3. Moreover, the rib 3c is provided in a part of the front cover 3. Therefore, this embodiment only requires the user to put the disc 4 on the rib 3c and operate the device to start reproduction or recording. Then, the disc 4 is moved automatically so that the center of the disc 4 is aligned with the center of the turntable 1, and thus the disc 4 can be loaded easily.

The clamp base 10 is withdrawn to a position that does not overlap a projection plane of the disc carrying surface 3a of the front cover 3 in the vertical direction. Accordingly, the clamp base 10 is not an obstacle, but can make it easier for the user to insert/remove the disc.

Moreover, the clamp base 10 is moved perpendicularly to the direction of movement of the optical pickup 2. This can reduce the outer dimensions of the disc device in the direction of movement of the optical pickup.

For loading of the disc, the clamp base 10 is moved to the clamp position shown in FIG. 7, and then the open/close member 9 is moved to the position shown in FIG. 8 to open the aperture 3b. For removal of the disc, the open/close member 9 closes the aperture 3b, and then the clamp base 10 is moved to the standby position. Therefore, during each of the operations in the insertion/removal of the disc, in the recording/reproducing state, and between the insertion/removal of the disc and the recording/reproducing state, the internal mechanism such as the turntable 1 always can be covered. With this configuration, the disc 4 can be inserted/removed easily because there is no obstacle to the insertion/removal of the disc 4 into/from the disc device. Moreover, when a user inserts/removes the disc 4, it is possible to prevent contact of the disc 4 with the turntable 1 or the optical pickup 2, so that the turntable 1, the optical pickup 2, and the disc 4 can be protected. This configuration also allows the internal mechanism to be invisible from the front of the device (i.e., the user side), thereby improving the appearance of the disc device.

Due to the presence of the open/close member 9, the mechanism such as the traverse base 5 inside the front cover 3 cannot be seen from the outside before loading the disc, and thus the aesthetic appearance and distinction can be improved. In the state of FIG. 3, since the traverse base 5 is covered with the open/close member 9, the components mounted on the traverse base 5 can be protected from external factors. In particular, considering the fact that the optical pickup 2 is susceptible to dust etc., the open/close member 9 serves not only to prevent the intrusion of dust into the device, but also to suppress or reduce the adhesion of dust to the optical pickup 2 or the like.

The open/close member 9 and the surface (the disc carrying surface side) of the clamp base 10 may be formed with the same color, material and treatment as those of the disc carrying surface 3a. This can enhance the conformity with the disc carrying surface 3a when the open/close member 9 is at the first position, thus improving the distinction of the disc device.

In this embodiment, the open operation of the open/close member 9 is started after the clamp base 10 has been moved to the clamp position. However, the open operation of the open/close member 9 may be started before the clamp base 10 reaches the clamp position.

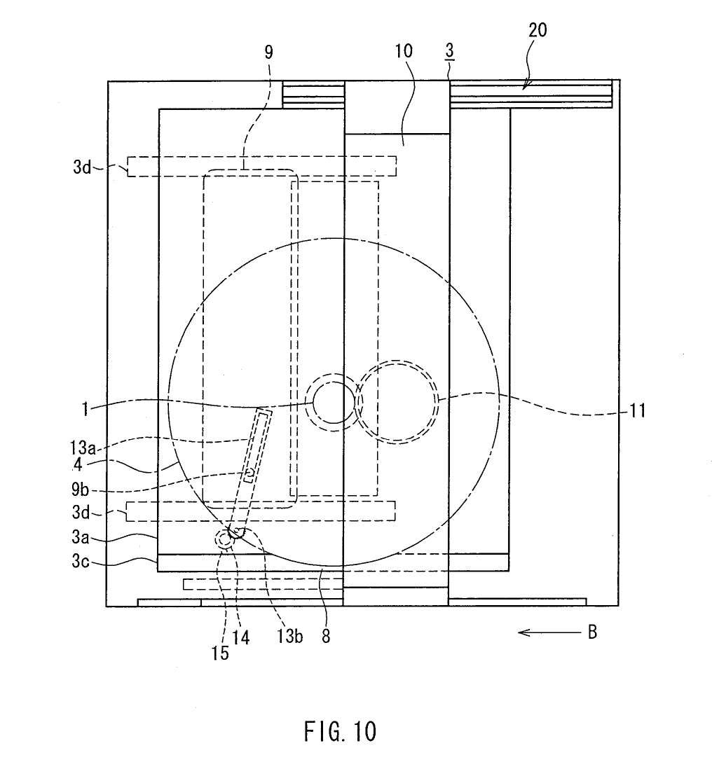

For example, the clamp base 10 in the state of FIG. 3 starts moving in the direction of the arrow B, and the open/close member 9 starts moving (in the direction of the arrow E) at the time the clamp base 10 is moved to a position where a part of the clamp base 10 overlaps a part of the open/close member 9 when viewed on a projection plane, as shown in FIG. 10. The open/close member 9 and the clamp base 10 can slide in the direction of the arrow E at approximately the same speed. Although the sliding movement of the clamp base 10 is stopped when it reaches the clamp position, the open/close member 9 continues to slide until reaching the second position shown in FIG. 8.

Reversing the above procedure can make a transition to a state in which the disc 4 can be removed. Specifically, the open/close member 9 in the state of FIG. 8 starts sliding in the direction of the arrow F, and the clamp base 10 starts moving (in the direction of the arrow F) at the time the open/close member 9 is moved to a position where a part of the open/close member 9 overlaps a part of the clamp base 10 when viewed on a projection plane. The open/close member 9 and the clamp base 10 can slide in the direction of the arrow F at approximately the same speed. The sliding movement of the open/close member 9 is stopped when it reaches the position (FIG. 3) to close the aperture 3b. However, the clamp base 10 continues to slide further and is stopped at the standby position (FIG. 3).

These operations can reduce the time required for insertion/removal of the disc 4. Moreover, in the course of movement of the open/close member 9 and the clamp base 10, a part of the clamp base 10 and a part of the open/close member 9 overlap, as shown in FIG. 10. Thus, it is possible to make the inside of the aperture 3b invisible from the outside.

This embodiment also can be applied to the loading of a disc contained in a case (referred to as “cartridge” in the following). The device loaded with a cartridge differs from that loaded with a disc in that, although not shown in the drawings, the former requires a shutter open/close mechanism for opening the shutter of the cartridge before the traverse is moved to the recording/reproducing position and closing the shutter after the traverse is moved to the standby position.

Moreover, this embodiment can be applied to a disc device dedicated to a disc that can record/reproduce only a disc, a disc device that can record/reproduce only a cartridge, and a disc device that can record/reproduce both a disc and a cartridge.

The present invention is not limited to the above embodiment.

### INDUSTRIAL APPLICABILITY

The disc device of the present invention can facilitate the loading of a disc, protect the traverse portion, and improve the appearance, and therefore is useful for a stationary disc device such as a DVD player or DVD recorder, a CD player, a computer equipped with a disc drive, etc.

1. A disc device capable of recording/reproducing information signals with respect to a disc comprising:
a traverse base that can be moved between a recording/reproducing position and a standby position, on which an optical pickup for recording/reproducing the information signals with respect to the disc and a turntable for rotating the disc at a position where the optical pickup can record/reproduce the information signals with respect to the disc are mounted;
a front cover comprising a disc carrying surface that can carry the disc and is fixed between a position of a disc holding portion of the turntable when the traverse base is at the recording/reproducing position and a position of the disc holding portion of the turntable when the traverse base is at the standby position, and an aperture that is formed in the disc carrying surface so as to allow the traverse base to be moved between the standby position and the recording/reproducing position;
a clamp base that can be moved between a first position where the clamp base is located parallel to the disc carrying surface and does not overlap the disc carrying surface and a second position where the clamp base overlaps the aperture, has a size large enough to cover the aperture at the second position, and comprises a damper for clamping the disc to the turntable; and
an open/close member that is movably provided at a back of the front cover and can be moved to cover/uncover the aperture,
wherein when the disc is clamped, the clamp base is moved from a standby position to a position where the clamp base overlaps the aperture, then the open/close member is moved from a position where the aperture is closed to a position where the aperture is opened, and subsequently the traverse base is moved from the standby position to the recording/reproducing position, thereby clamping the disc with the turntable and the clamper.

2. The disc device according to claim 1, wherein during a transition from insertion of the disc to a recording/reproducing state, the clamp base is moved to a position where the clamp base covers the aperture that is exposed as the open/close member opens, and during a transition from the recording/reproducing state to removal of the disc, the clamp base stays at the position to cover the aperture until the open/close member closes so that the aperture disappears, and subsequently is moved to the standby position.

3. The disc device according to claim 1, wherein the open/close member has a recess in a portion opposed to the turntable.
